(19) United States
(12) Patent Application Publication
(10) Pub. No.: US 2019/0384458 A1
(43) Pub. Date: Dec. 19, 2019

(54) Touchscreen and Touch Display Apparatus

(71) Applicant: Huawei Technologies Co., Ltd., Shenzhen (CN)

(72) Inventor: Shuqiang GONG, Shenzhen (CN)

(21) Appl. No.: 16/486,738

(22) PCT Filed: May 5, 2017
(86) PCT No.: PCT/CN2017/083179

§ 371 Date: Aug. 16, 2019

(30) Foreign Application Priority Data
Feb. 16, 2017 (CN) 201710084647.0

(51) Int. Cl. G06F 3/044

(52) U.S. Cl. CPC G06F 3/0447; G06F 2203/04105

(57) ABSTRACT

A touchscreen and a touch display apparatus are disclosed. The touchscreen includes a transparent substrate, the transparent substrate includes a first surface and a second surface, a transparent first conductive layer is disposed on the first surface, a transparent second conductive layer is disposed on the second surface, the first conductive layer includes a plurality of first touch induction electrodes and first pressure induction electrodes that extend in a first direction and that are alternately arranged in a second direction, the second conductive layer includes a plurality of second touch induction electrodes and second pressure induction electrodes that extend in the second direction and that are alternately arranged in the first direction, the plurality of first touch induction electrodes and the plurality of second touch induction electrodes are configured to detect a position of a touch operation on the touchscreen, and the plurality of first pressure induction electrodes and the plurality of second pressure induction electrodes are configured to detect pressure of the touch operation on the touchscreen. The touchscreen can detect touch pressure without increasing thickness of the touchscreen.

### TECHNICAL FIELD

The present invention relates to the field of touch control technologies, and in particular, to a touchscreen and a touch display apparatus.

### BACKGROUND

In a pressure detection technology, a touch pressure value may be added to a touch position on a conventional capacitive touchscreen. To be specific, a touch detection result changes from original two-dimensional coordinates (x, y) to three-dimensional coordinates (x, y, z), to achieve three-dimensional touch control experience, where x and y respectively indicate a horizontal coordinate and a vertical coordinate of the touch position, and z indicates a value of touch pressure, A pressure detection function is introduced to the touchscreen, so that an expression range can be enlarged and efficiency of touch control input can be improved. Currently, there is a solution in which touch pressure is determined by detecting a size of a finger contact area by using the capacitive touchscreen. However, in this solution, there may be a large error for fingers of different users. In addition, there is also a solution in which an extra pressure sensor is added to detect touch pressure. However, because the sensor is not transparent, the sensor cannot be disposed above a display screen. Instead, the sensor can be disposed only around the display screen. Consequently, a glass cover plate is mounted in limited manners, and a waterproof design is affected. Alternatively, the pressure sensor is disposed on the back of the display screen by using a substrate, and deformation of the glass cover plate under pressure can be transmitted to the pressure sensor on the back of the screen only when the display screen is deformed due to compression. Consequently, sensitivity of pressure detection is low, and reliability of the screen is affected, in addition, thickness of the touchscreen needs to be increased due to disposing of the pressure sensor, and there are problems of a high assembly difficulty, high costs, and the like.

### SUMMARY

Embodiments of the present invention provide a touchscreen and a touch display apparatus, to detect pressure of a touch operation based on a capacitive touchscreen without increasing thickness of the touchscreen, thereby reducing manufacturing costs and an assembly difficulty of the touchscreen.

A first aspect of the embodiments of the present invention provides a touchscreen, including a transparent substrate, where the transparent substrate includes a first surface and a second surface that are opposite to each other, a transparent first conductive layer is disposed on the first surface, a transparent second conductive layer is disposed on the second surface, the first conductive layer includes a plurality of first touch induction electrodes and first pressure induction electrodes that extend in a first direction, the first touch induction electrodes and the first pressure induction electrodes are alternately arranged in a second direction, the second conductive layer includes a plurality of second touch induction electrodes and second pressure induction electrodes that extend in the second direction, the second touch induction electrodes and the second pressure induction electrodes are alternately arranged in the first direction, the plurality of first touch induction electrodes and the plurality of second touch induction electrodes are configured to detect a position of a touch operation on the touchscreen, and the plurality of first pressure induction electrodes and the plurality of second pressure induction electrodes are configured to detect pressure of the touch operation on the touchscreen.

In this embodiment, the first touch induction electrodes and the first pressure induction electrodes that are alternately arranged are formed on the first conductive layer, and the second touch induction electrodes and the second pressure induction electrodes that are alternately arranged are formed on the second conductive layer, so that the first touch induction electrodes and the second touch induction electrodes can be used to detect the position of the touch operation on the touchscreen, and the first pressure induction electrodes and the second pressure induction electrodes can be used to detect the pressure of the touch operation on the touchscreen. Therefore, the pressure of the touch operation can be detected without increasing thickness of the touchscreen. In addition, because the first conductive layer and the second conductive layer both are transparent, the touchscreen may be directly fitted to a display screen, thereby helping reducing manufacturing costs and an assembly difficulty.

In an implementation, the first touch induction electrode includes a plurality of sequentially connected first touch induction regions, the first pressure induction electrode includes a plurality of sequentially connected first pressure induction regions, and the plurality of first touch induction regions of the first touch induction electrode and a plurality of first pressure induction regions of a neighboring first pressure induction electrode are alternately arranged.

In this implementation, the first touch induction electrode is disposed as the plurality of sequentially connected first touch induction regions, so that a plurality of corresponding hollow-out regions that are communicated with each other may be formed between two neighboring first touch induction electrodes. The plurality of sequentially connected first pressure induction regions are further disposed in the hollow-out regions to form the first pressure induction electrodes, so as to form, on the same transparent substrate, the first touch induction electrodes configured to detect the position of the touch operation and the first pressure induction electrodes configured to detect the pressure of the touch operation. Therefore, pressure caused by touch is detected without increasing the thickness of the touchscreen.

In an implementation, the second touch induction electrode includes a plurality of sequentially connected second touch induction regions, the second pressure induction electrode includes a plurality of sequentially connected second pressure induction regions, and the plurality of second touch induction regions of the second touch induction electrode and a plurality of second pressure induction regions of a neighboring second pressure induction electrode are alternately arranged.

In this implementation, the second touch induction electrode is disposed as the plurality of sequentially connected second touch induction regions, so that a plurality of corresponding hollow-out regions that are communicated with each other may be formed between two neighboring second touch induction electrodes. The plurality of sequentially connected second pressure induction regions are further disposed in the hollow-out regions to form the second pressure induction electrodes, so as to form, on the same transparent substrate, the second touch induction electrodes configured to detect the position of the touch operation and the second pressure induction electrodes configured to detect the pressure of the touch operation. Therefore, pressure caused by touch is detected without increasing the thickness of the touchscreen.

In an implementation, the first touch induction electrodes and the first pressure induction electrodes are conductive patterns formed based on the first conductive layer, and the second touch induction electrodes and the second pressure induction electrodes are conductive patterns formed based on the second conductive layer.

In this implementation, because the first conductive layer and the second conductive layer both are transparent, the first pressure induction electrodes and the second pressure induction electrodes all are transparent. Therefore, when the touchscreen is applied to a touch display apparatus, the touchscreen may be directly fitted to a display screen of the touch display apparatus, so as to shorten a pressure transmission path during a touch operation, and improve sensitivity of pressure touch control.

In an implementation, the first touch induction electrodes and the first pressure induction electrodes are formed based on the first conductive layer through etching, laser carving, or another process. The second touch induction electrodes and the second pressure induction electrodes are formed based on the second conductive layer through etching, laser carving, or another process.

In this implementation, the touch induction electrodes and the pressure induction electrodes are formed on the same conductive layer through etching, laser carving, or another process, so that a manufacturing process of the touchscreen can be effectively shortened, and manufacturing costs can be reduced.

In an implementation, the conductive patterns of the first touch induction electrodes are the same as the conductive patterns of the second touch induction electrodes, and the conductive patterns of the first pressure induction electrodes are the same as the conductive patterns of the second pressure induction electrodes.

In an implementation, the conductive patterns of the first touch induction electrodes complement the conductive patterns of the first pressure induction electrodes, and the conductive patterns of the second touch induction electrodes complement the conductive patterns of the second pressure induction electrodes.

In an implementation, the conductive patterns of the first touch induction electrodes complement the conductive patterns of the second touch induction electrodes in an orthogonal projection direction, and the conductive patterns of the first pressure induction electrodes complement the conductive patterns of the second pressure induction electrodes in the orthogonal projection direction.

In an implementation, the first pressure induction electrodes and the second pressure induction electrodes are strain resistance lines of a roundabout structure.

In this implementation, the first pressure induction electrodes and the second pressure induction electrodes are disposed as the strain resistance lines of the roundabout structure, so that a longer strain resistance line can be disposed in a pressure induction region having a same area, and the strain resistance line of the roundabout structure also can enable a pressure induction electrode to be more sensitive when the pressure induction electrode is deformed under pressure, so as to sensitively change a resistance value of a strain resistor according to a pressure change, and improve sensitivity of pressure detection.

A second aspect of the embodiments of the present invention provides a touch display apparatus, including a display screen and a touchscreen, where the display screen includes a display surface, the touchscreen is fitted to the display surface, and is configured to receive a three-dimensional touch operation on the touch display apparatus, and the touchscreen is the touchscreen described in the first aspect of the embodiments of the present invention and any implementation of the first aspect.

In this embodiment, because the first conductive layer and the second conductive layer both are transparent, when the touchscreen is directly fitted to the display surface of the display screen, pressure of the three-dimensional touch operation can be detected without increasing thickness of the touch display apparatus, and manufacturing costs and an assembly difficulty of the touch display apparatus also can be reduced.

In an implementation, the touch display apparatus further includes a transparent cover plate, and the transparent cover plate is fitted to the touchscreen.

In this implementation, the touchscreen is directly fitted to the display screen of the touch display apparatus, and the transparent cover plate is fitted to the touchscreen, so as to protect the touchscreen. In addition, because the touchscreen is closely fitted to the transparent cover plate, a pressure transmission path during a touch operation can be shortened, and sensitivity of pressure touch control can be improved.

In an implementation, the touch display apparatus further includes a processor, and the first touch induction electrodes, the second touch induction electrodes, the first pressure induction electrodes, and the second pressure induction electrodes all are led to a non-display region of the touch display apparatus through transparent electrode wires, and are further electrically connected to the processor.

In this implementation, the touch induction electrodes and the pressure induction electrodes are led to the non-display region of the touch display apparatus through the transparent electrode wires, and are further electrically connected to the processor. The transparent electrode wires may be formed, through etching or another process, based on a conductive layer the same as the conductive layer of the touch induction electrodes and the pressure induction electrodes, so that the transparent electrode wires have transparency the same as that of the touch induction electrodes and the pressure induction electrodes, so as to prevent the electrode wires from blocking the display screen.

In an implementation, the processor is configured to: obtain inducting voltages output by the plurality of first touch induction electrodes and the plurality of second touch induction electrodes, and determine a position of the three-dimensional touch operation on the touch display apparatus based on values of the inducting voltages output by the plurality of first touch induction electrodes and the plurality of second touch induction electrodes.

In this implementation, the plurality of first touch induction electrodes extend in a first direction and are arranged in a second direction, and the plurality of second touch induction electrodes extend in the second direction and are arranged in the first direction. Therefore, a position of the three-dimensional touch operation on the touch display apparatus in the second direction can be determined by detecting inducting voltages output by the plurality of first touch induction electrodes, and a position of the three-dimensional touch operation on the touch display apparatus in the first direction can be determined by detecting inducting voltages output by the plurality of second touch induction electrodes, so as to determine the position of the three-dimensional touch operation on the touch display apparatus based on the position in the second direction and the position in the first direction.

In an implementation, the processor is configured to: obtain inducting voltages output by the plurality of first pressure induction electrodes and the plurality of second pressure induction electrodes, and determine pressure of the three-dimensional touch operation on the touch display apparatus based on values of the inducting voltages output by the plurality of first pressure induction electrodes and the plurality of second pressure induction electrodes.

In this implementation, the plurality of first pressure induction electrodes extend in a first direction and are arranged in a second direction, and the plurality of second pressure induction electrodes extend in the second direction and are arranged in a first direction. Therefore, pressure distribution of the three-dimensional touch operation on the touch display apparatus in a second direction can be determined by detecting inducting voltages output by the plurality of first pressure induction electrodes, and pressure distribution of the three-dimensional touch operation on the touch display apparatus in the first direction can be determined by detecting inducting voltages output by the plurality of second pressure induction electrodes, so as to determine the pressure of the three-dimensional touch operation on the touch display apparatus based on the pressure distribution in the second direction and the pressure distribution in the first direction.

### DESCRIPTION OF DRAWINGS

To describe the technical solutions in the embodiments of the present invention more clearly, the following briefly describes the accompanying drawings required for describing the embodiments of the present invention.

FIG. 1 is a first schematic structural diagram of a touchscreen according to an embodiment of the present invention;

FIG. 2 is a second schematic structural diagram of a touchscreen according to an embodiment of the present invention;

FIG. 3 is a third schematic structural diagram of a touchscreen according to an embodiment of the present invention;

FIG. 4 is a schematic diagram of a pressure detection principle of a touchscreen according to an embodiment of the present invention; and

FIG. 5 is a schematic structural diagram of a touch display apparatus according to an embodiment of the present invention.

### DESCRIPTION OF EMBODIMENTS

The following describes the embodiments of the present invention with reference to accompanying drawings.

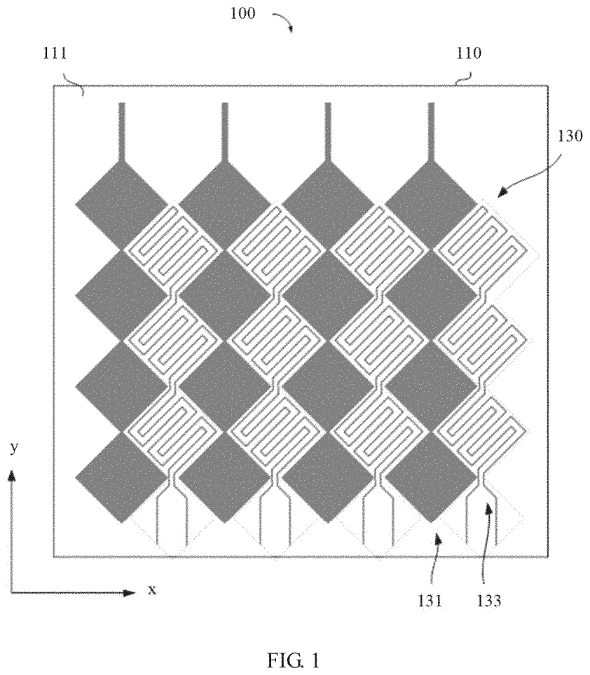

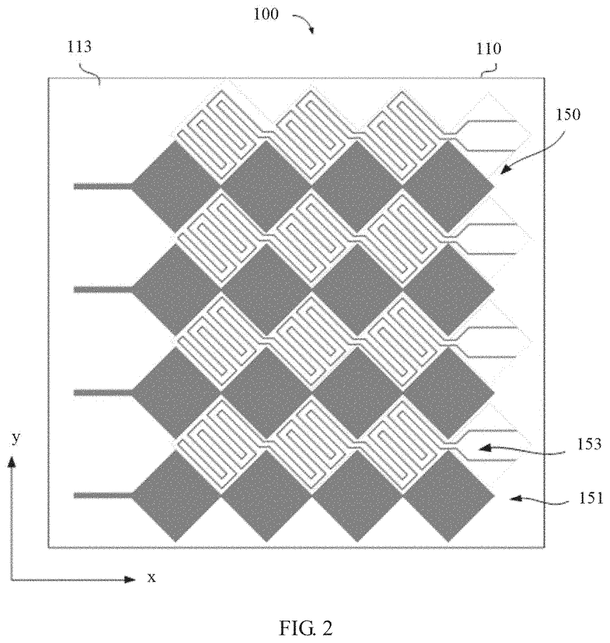

Referring to both FIG. 1 and FIG. 2, an embodiment of the present invention provides a touchscreen 100, and the touchscreen 100 includes a transparent substrate 110. The transparent substrate 110 includes a first surface 111 and a second surface 113 that are opposite to each other, a transparent first conductive layer 130 is disposed on the first surface 111, a transparent second conductive layer 150 is disposed on the second surface 113, the first conductive layer 130 includes a plurality of first touch induction electrodes 131 and first pressure induction electrodes 133 that extend in a first direction, the first touch induction electrodes 131 and the first pressure induction electrodes 133 are alternately arranged in a second direction, the second conductive layer 150 includes a plurality of second touch induction electrodes 151 and second pressure induction electrodes 153 that extend in the second direction, the second touch induction electrodes 151 and the second pressure induction electrodes 153 are alternately arranged in the first direction, the plurality of first touch induction electrodes 131 and the plurality of second touch induction electrodes 151 are configured to detect a position of a touch operation on the touchscreen 100, and the plurality of first pressure induction electrodes 133 and the plurality of second pressure induction electrodes 153 are configured to detect pressure of the touch operation on the touchscreen 100.

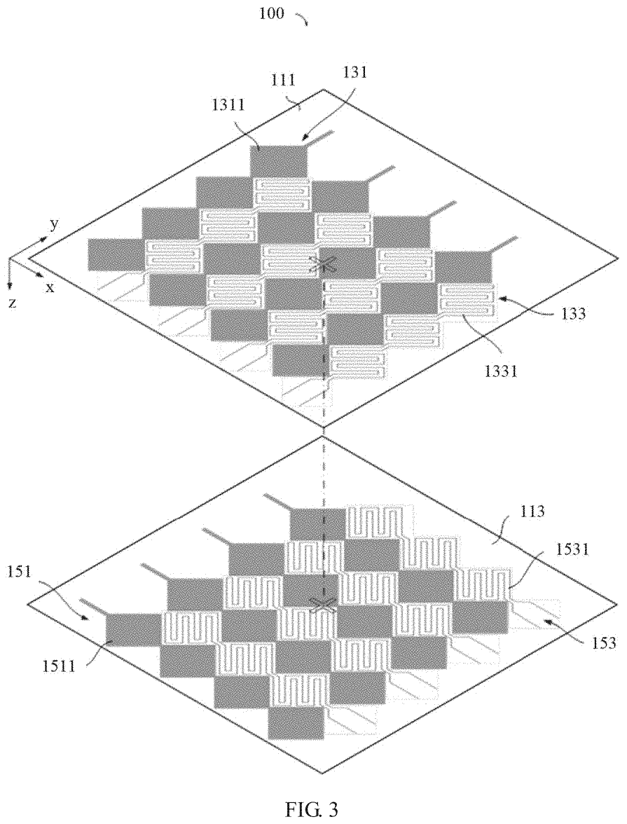

In this embodiment, the first direction is orthogonal to the second direction, a plane of the first direction and the second direction is parallel to the first surface 111 and the second surface 113, and a direction of the pressure of the touch operation is perpendicular to the first surface 111 and the second surface 113. It may be understood that in an implementation, a three-dimensional coordinate system may be set up. As shown in FIG. 3, a direction along a y axis is the first direction, a direction along an x axis is the second direction, and a direction along a z axis is the direction of the pressure of the touch operation.

In this embodiment, the first touch induction electrodes 131 and the first pressure induction electrodes 133 that are alternately arranged are formed on the first conductive layer 130, and the second touch induction electrodes 151 and the second pressure induction electrodes 153 that are alternately arranged are formed on the second conductive layer 150, so that the first touch induction electrodes 131 and the second touch induction electrodes 151 can be used to detect the position of the touch operation on the touchscreen 100, and the first pressure induction electrodes 133 and the second pressure induction electrodes 153 can be used to detect the pressure of the touch operation on the touchscreen 100. Therefore, the pressure of the touch operation can be detected without increasing thickness of the touchscreen 100. In addition, because the first conductive layer 130 and the second conductive layer 150 both are transparent, the touchscreen 100 may be directly fitted to a display screen, thereby helping reducing manufacturing costs and an assembly difficulty.

Referring to FIG. 3, in an implementation, the first touch induction electrode 131 includes a plurality of sequentially connected first touch induction regions 1311, the first pressure induction electrode 133 includes a plurality of sequentially connected first pressure induction regions 1331, and the plurality of first touch induction regions 1311 of the first touch induction electrode 131 and a plurality of first pressure induction regions 1331 of a neighboring first pressure induction electrode 133 are alternately arranged.

The second touch induction electrode 151 includes a plurality of sequentially connected second touch induction regions 1511, the second pressure induction electrode 153 includes a plurality of sequentially connected second pressure induction regions 1531, and the plurality of second touch induction regions 1511 of the second touch induction electrode 151 and a plurality of second pressure induction regions 1531 of a neighboring second pressure induction electrode 153 are alternately arranged.

In this implementation, the first touch induction electrode 131 is disposed as the plurality of sequentially connected first touch induction regions 1311, so that a plurality of corresponding hollow-out regions that are communicated with each other may be formed between two neighboring first touch induction electrodes 131. The plurality of sequentially connected first pressure induction regions 1331 are further disposed in the hollow-out regions to form the first pressure induction electrodes 133. The second touch induction electrode 151 is disposed as the plurality of sequentially connected second touch induction regions 1511, so that a. plurality of corresponding hollow-out regions that are communicated with each other may be formed between two neighboring second touch induction electrodes 151. The plurality of sequentially connected second pressure induction regions 1531 are further disposed in the hollow-out regions to form the second pressure induction electrodes 153. Therefore, the touch induction electrodes configured to detect the position of the touch operation and the pressure induction electrodes configured to detect the pressure of the touch operation are formed on the same transparent substrate, and pressure caused by touch is detected without increasing the thickness of the touchscreen 100.

It may be understood that in an implementation, the first touch induction regions 1311, the first pressure induction regions 1331, the second touch induction regions 1511, and the second pressure induction regions 1531 all may be disposed as rhombus-shaped regions, first touch induction regions 1311 of any two neighboring first touch induction electrodes 131 are aligned with each other in the second direction, first pressure induction regions 1331 of any two neighboring first pressure induction electrodes 133 are aligned with each other in the second direction, second touch induction regions 1511 of any two neighboring second touch induction electrodes 151 are aligned with each other in the first direction, and second pressure induction regions 1531 of any two neighboring second pressure induction electrodes 153 are aligned with each other in the first direction.

In this embodiment, the first touch induction electrodes 131 and the first pressure induction electrodes 133 are conductive patterns formed based on the first conductive layer 130, and the second touch induction electrodes 151 and the second pressure induction electrodes 153 are conductive patterns formed based on the second conductive layer 150. The conductive patterns of the first touch induction electrodes 131 are the same as the conductive patterns of the second touch induction electrodes 151, and the conductive patterns of the first pressure induction electrodes 133 are the same as the conductive patterns of the second pressure induction electrodes 153. The conductive patterns of the first touch induction electrodes 131 complement the conductive patterns of the first pressure induction electrodes 133, and the conductive patterns of the second touch induction electrodes 151 complement the conductive patterns of the second pressure induction electrodes 153. The conductive patterns of the first touch induction electrodes 131 complement the conductive patterns of the second touch induction electrodes 151 in an orthogonal projection direction, and the conductive patterns of the first pressure induction electrodes 133 complement the conductive patterns of the second pressure induction electrodes 153 in the orthogonal projection direction. The orthogonal projection direction is a direction in which a projection line is perpendicular to the first conductive layer 130 and the second conductive layer 150. That the conductive patterns of the first touch induction electrodes 131 complement the conductive patterns of the second touch induction electrodes 151 in the orthogonal projection direction means that projections of the first touch induction regions 1311 of the first touch induction electrodes 131 on the second conductive layer 150 are in gaps between the second touch induction regions 1511 of the second touch induction electrodes 151, and complement the second touch induction regions 1511. In other words, the projections of the first touch induction regions 1311 on the second conductive layer 150 are in regions intersecting with the second touch induction regions 1511.

It may be understood that the first touch induction electrodes 131 and the first pressure induction electrodes 133 may be formed based on the first conductive layer 130 through etching, laser carving, or another process. The second touch induction electrodes 151 and the second pressure induction electrodes 153 may be formed based on the second conductive layer 150 through etching, laser carving, or another process. It may be understood that the touch induction electrodes and the pressure induction electrodes are formed on the same conductive layer through etching, laser carving, or another process, so that a manufacturing process of the touchscreen can be effectively shortened, and manufacturing costs can be reduced.

In an implementation, the first pressure induction electrodes 133 and the second pressure induction electrodes 153 are strain resistance lines of a roundabout structure. It may be understood that a specific roundabout form of the strain resistance line of the roundabout structure is not limited herein. For example, the strain resistance line may be of a square roundabout structure shown in FIG. 3, or may be a rhombus-shaped roundabout structure, a circular roundabout structure, or a roundabout structure in another form.

The first pressure induction electrodes 133 and the second pressure induction electrodes 153 are disposed as the strain resistance lines of the roundabout structure, so that a longer strain resistance line can be disposed in a pressure induction region having a same area, and the strain resistance line of the roundabout structure also can enable a pressure induction electrode to be more sensitive when the pressure induction electrode is deformed under pressure, so as to sensitively change a resistance value of a strain resistor according to a pressure change, and improve sensitivity of pressure detection.

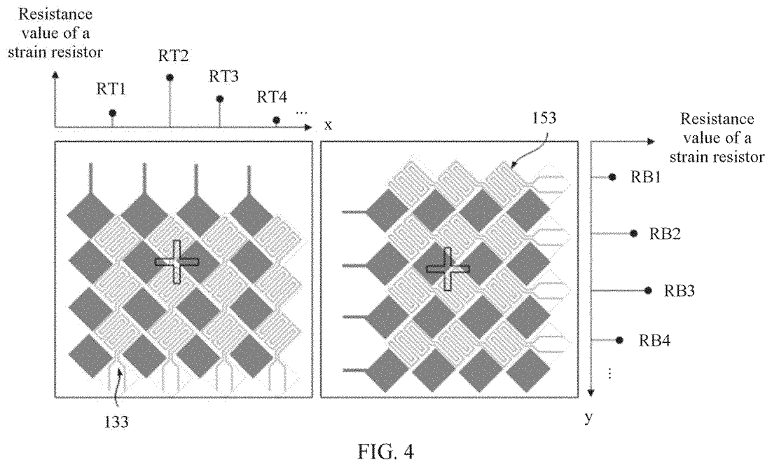

Referring to FIG. 4, it is assumed that strain resistors corresponding to the plurality of first pressure induction electrodes 133 are RT1, RT2, RT3, RT4, and the like, and strain resistors corresponding to the plurality of second pressure induction electrodes 153 are RB1, RB2, RB3, RB4, and the like. It may be understood that when no touch operation on the touchscreen 100 is received, or a touch operation has no pressure, resistance values of the strain resistors RT1, RT2, RT3, RT4, and the like, and resistance values of the strain resistors RB1, RB2, RB3, RB4, and the like do not change. When pressure acts on the touchscreen 100, the resistance values of the strain resistors RT1, RT2, RT3, RT4, and the like, and the resistance values of the strain resistors RB1, RB2, RB3, RB4, and the like change, and a resistance value of a strain resistor closer to a contact point of the touch operation changes more greatly. Therefore, it can be determined, by separately detecting the resistance values of the strain resistors RT1, RT2, RT3, RT4, and the like, and the resistance values of the strain resistors RB1, RB2, RB3, RB4, and the like, that the position of the touch operation is located on an intersection between a first pressure induction electrode 133 having a largest resistance value (for example, RTi) and a second pressure induction electrode 153 having a largest resistance value (for example, RBj). In addition, the pressure of the touch operation may be calculated based on a resistance value RTi of a strain resistor corresponding to the first pressure induction electrode 133 having the largest resistance value and a resistance value RBj of a strain resistor corresponding to the second pressure induction electrode 153 having the largest resistance value.

As shown in FIG. 4, it is assumed that a position shown by a symbol “+” is the position of the touch operation, and the touch operation carries pressure. In addition, if the position of the touch operation is close to the intersection between the first pressure induction electrode 133 whose strain resistor is RT2 and the second pressure induction electrode 153 whose strain resistor is RB3, corresponding resistance values of the strain resistors RT2 and RB3 are the largest because deformation generated under pressure by the first pressure induction electrode 133 corresponding to the strain resistor RT2 and deformation generated under pressure by the second pressure induction electrode 153 corresponding to the strain resistor RB3 are the largest. To be specific, it may be learned, by separately detecting the resistance values of the strain resistors RT1, RT2, RT3, RT4, and the like, and the resistance values of the strain resistors RB1, RB2, RB3, RB4, and the like, that the resistance values of the strain resistors RI2 and RB3 are the largest, and a position of a pressure point of the touch operation may be determined based on a position of the first pressure induction electrode 133 corresponding to the strain resistor RT2 and a position of the second pressure induction electrode 153 corresponding to the strain resistor RB3. In addition, a pressure value corresponding to the touch operation may be further calculated based on changes of the resistance values of the strain resistors RT2 and RB3.

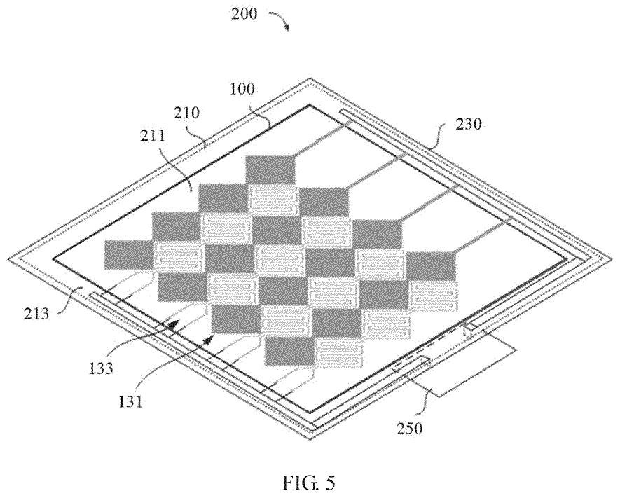

Referring to FIG. 5, an embodiment of the present invention provides a touch display apparatus 200, and the touch display apparatus includes a display screen 210 and a touchscreen 100. The display screen 210 includes a display surface 211, and the touchscreen 100 is fitted to the display surface 211, and is configured to receive a three-dimensional touch operation on the touch display apparatus. For a specific structure and a function of the touchscreen 100, refer to the descriptions in the embodiments shown in FIG. 1 to FIG. 4. Details are not described herein again.

In an implementation, the touch display apparatus 200 further includes a transparent cover plate 230. The transparent cover plate 230 is fitted to the touchscreen 100, so that the touchscreen 100 is closely fitted between the display screen 210 and the transparent cover plate 230. It may be understood that the touchscreen 100 is directly fitted to the display screen 210 of the touch display apparatus, and the transparent cover plate 230 is fitted to the touchscreen 100, so as to protect the touchscreen 230. In addition, because the touchscreen 100 is closely fitted to the transparent cover plate 230, a pressure transmission path during a touch operation can be shortened, and sensitivity of pressure touch control can be improved.

In an implementation, the touch display apparatus further includes a processor 250, and the processor 250 may be disposed on a circuit board (not shown in the figure). The first touch induction electrodes 131, the second touch induction electrodes 151, the first pressure induction electrodes 133. and the second pressure induction electrodes 153 all are led to a non-display region 213 of the touch display apparatus 200 through transparent electrode wires, and are further electrically connected to the processor 250 through wires in the non-display region 213. It may be understood that FIG. 5 shows only a manner of connecting the first touch induction electrodes 131 and the first pressure induction electrodes 133 to the processor 250, and the second touch induction electrodes 151 and the second pressure induction electrodes 153 may be electrically connected to the processor 250 with reference to the manner of connecting the first touch induction electrodes 131 and the first pressure induction electrodes 133 to the processor 250.

In this implementation, the touch induction electrodes and the pressure induction electrodes are led to the non-display region 213 of the touch display apparatus 200 through the transparent electrode wires, and are further electrically connected to the processor 250. The transparent electrode wires may be formed, through etching or another process, based on a conductive layer the same as the conductive layer of the touch induction electrodes and the pressure induction electrodes, so that the transparent electrode wires have transparency the same as that of the touch induction electrodes and the pressure induction electrodes, so as to prevent the electrode wires from blocking the display screen.

In an implementation, the processor 250 is configured to: obtain inducting voltages output by the plurality of first touch induction electrodes 131 and the plurality of second touch induction electrodes 151, and determine a position of the three-dimensional touch operation on the touch display apparatus 200 based on values of the inducting voltages output by the plurality of first touch induction electrodes 131 and the plurality of second touch induction electrodes 151.

In this implementation, the plurality of first touch induction electrodes 131 extend in a first direction and are arranged in a second direction, and the plurality of second touch induction electrodes 151 extend in the second direction and are arranged in the first direction. Therefore, a position of the three-dimensional touch operation on the touch display apparatus 200 in the second direction can be determined by detecting inducting voltages output by the plurality of first touch induction electrodes 131, and a position of the three-dimensional touch operation on the touch display apparatus 200 in the first direction can be determined by detecting inducting voltages output by the plurality of second touch induction electrodes 151, so as to determine the position of the three-dimensional touch operation on the touch display apparatus 200 based on the position in the second direction and the position in the first direction.

In an implementation, the processor 250 is configured to: obtain inducting voltages output by the plurality of first pressure induction electrodes 133 and the plurality of second pressure induction electrodes 153, and determine pressure of the three-dimensional touch operation on the touch display apparatus 200 based on values of the inducting voltages output by the plurality of first pressure induction electrodes 133 and the plurality of second pressure induction electrodes 153.

In this implementation, the plurality of first pressure induction electrodes 133 extend in a first direction and are arranged in a second direction, and the plurality of second pressure induction electrodes 153 extend in the second direction and are arranged in the first direction. Therefore, pressure distribution of the three-dimensional touch operation on the touch display apparatus 200 in the second direction can be determined by detecting inducting voltages output by the plurality of first pressure induction electrodes 133, and pressure distribution of the three-dimensional touch operation on the touch display apparatus 200 in the first direction can be determined by detecting inducting voltages output by the plurality of second pressure induction electrodes 153, so as to determine the pressure of the three-dimensional touch operation on the touch display apparatus 200 based on the pressure distribution in the second direction and the pressure distribution in the first direction.

1. A touchscreen comprising:
a transparent substrate comprising:
a first surface; and
a second surface that opposes the first surface;
a transparent first conductive layer disposed on the first surface and comprising a plurality of first touch induction electrodes and first pressure induction electrodes that extend in a first direction and are alternately arranged in a second direction;
a transparent second conductive layer disposed on the second surface and comprising a plurality of second touch induction electrodes and second pressure induction electrodes that extend in the second direction and are alternately arranged in the first direction,
wherein the first touch induction electrodes and the second touch induction electrodes are configured to detect a position of a touch operation, and
wherein the first pressure induction electrodes and the second pressure induction electrodes are configured to detect pressure of the touch operation on the touchscreen.

2. The touchscreen of claim 1, wherein the first touch induction electrodes comprise a plurality of sequentially connected first touch induction regions, wherein the first pressure induction electrodes comprise a plurality of sequentially connected first pressure induction regions, and wherein the sequentially connected first touch induction regions of a first touch induction electrode and the first sequentially connected pressure induction regions of a neighboring first pressure induction electrode are alternately arranged.

3. The touchscreen of claim 1, wherein the second touch induction electrode further comprises a plurality of sequentially connected second touch induction regions, wherein the second pressure induction electrode further comprises a plurality of sequentially connected second pressure induction regions, and wherein the plurality of second touch induction regions of the second touch induction electrode and a plurality of second pressure induction regions of a neighboring second pressure induction electrode are alternately arranged.

4. The touchscreen of claim 1, wherein the first touch induction electrodes and the first pressure induction electrodes further comprise conductive patterns on the first conductive layer, and the second touch induction electrodes and the second pressure induction electrodes further comprise conductive patterns on the second conductive layer.

5. The touchscreen of claim 4, wherein the first touch induction electrodes and the second touch induction electrodes are of the same pattern, and wherein the first pressure induction electrodes and the second pressure induction electrodes are of the same pattern.

6. The touchscreen of claim 4, wherein the conductive patterns of the first touch induction electrodes complement the conductive patterns of the first pressure induction electrodes, and the conductive patterns of the second touch induction electrodes complement the conductive patterns of the second pressure induction electrodes.

7. The touchscreen of claim 4, wherein the conductive patterns of the first touch induction electrodes complement the conductive patterns of the second touch induction electrodes in an orthogonal projection direction, and the conductive patterns of the first pressure induction electrodes complement the conductive patterns of the second pressure induction electrodes in the orthogonal projection direction.

8. The touchscreen of claim 1, wherein the first pressure induction electrodes and the second pressure induction electrodes are strain resistance lines of a roundabout structure.

9. A touch display apparatus comprising:
a display screen having a display surface;
a touchscreen fitted to the display surface, and configured to receive a three-dimensional touch operation on the touch display apparatus, the touchscreen comprising:
a transparent substrate comprising:
a first surface; and
a second surface that opposes the first surface;
a transparent first conductive layer disposed on the first surface and comprising a plurality of first touch induction electrodes and first pressure induction electrodes that extend in a first direction and are alternately arranged in a second direction;
a transparent second conductive layer disposed on the second surface and comprising a plurality of second touch induction electrodes and second pressure induction electrodes that extend in the second direction and are alternately arranged in the first direction,
wherein the first touch induction electrodes and the second touch induction electrodes are configured to detect a position of a touch operation, and
wherein the first pressure induction electrodes and the second pressure induction electrodes are configured to detect pressure of the touch operation on the touchscreen.

10. The touch display apparatus of claim 9, wherein the touch display apparatus further comprises a transparent cover plate fitted to the touchscreen.

11. The touch display apparatus of claim 9, wherein the touch display apparatus further comprises a processor, wherein the first touch induction electrodes, the second touch induction electrodes, the first pressure induction electrodes, and the second pressure induction electrodes are electrically connected to a non-display region of the touch display apparatus through transparent electrode wires, and are electrically connected to the processor.

12. The touch display apparatus of claim 11, wherein the processor is configured to:
obtain voltages output by the plurality of first touch induction electrodes and the plurality of second touch induction electrodes; and
determine a position of the three-dimensional touch operation on the touch display apparatus based on values of the obtained voltages.

13. The touch display apparatus of claim 11, wherein the processor is configured to: obtain voltages output by the plurality of first pressure induction electrodes and the plurality of second pressure induction electrodes, and determine pressure of the three-dimensional touch operation on the touch display apparatus based on values of the obtained voltages.

14. The touch display apparatus of claim 9, wherein
the first touch induction electrode further comprises a plurality of sequentially connected first touch induction regions, wherein
the first pressure induction electrode further comprises a plurality of sequentially connected first pressure induction regions, and wherein
the plurality of first touch induction regions of the first touch induction electrode and a plurality of first pressure induction regions of a neighboring first pressure induction electrode are alternately arranged.

15. The touch display apparatus of claim 9, wherein
the second touch induction electrode further comprises a plurality of sequentially connected second touch induction regions, wherein
the second pressure induction electrode further comprises a plurality of sequentially connected second pressure induction regions, and wherein
the plurality of second touch induction regions of the second touch induction electrode and a plurality of second pressure induction regions of a neighboring second pressure induction electrode are alternately arranged.

16. The touch display apparatus of claim 9, wherein the first touch induction electrodes and the first pressure induction electrodes further comprise conductive patterns on the first conductive layer, and the second touch induction electrodes and the second pressure induction electrodes further comprise conductive patterns on the second conductive layer.

17. The touch display apparatus of claim 16, wherein the first touch induction electrodes and the second touch induction electrodes are of the same pattern, and wherein
the first pressure induction electrodes and the second pressure induction electrodes are of the same pattern.

18. The touch display apparatus of claim 16, wherein the conductive patterns of the first touch induction electrodes complement the conductive patterns of the first pressure induction electrodes, and the conductive patterns of the second touch induction electrodes complement the conductive patterns of the second pressure induction electrodes.

19. The touch display apparatus of claim 16, wherein the conductive patterns of the first touch induction electrodes complement the conductive patterns of the second touch induction electrodes in an orthogonal projection direction, and the conductive patterns of the first pressure induction electrodes complement the conductive patterns of the second pressure induction electrodes in the orthogonal projection direction.

20. The touch display apparatus of claim 9, wherein the first pressure induction electrodes and the second pressure induction electrodes are strain resistance lines of a roundabout structure.
